(19) United States
(12) Patent Application Publication
(10) Pub. No.: US 2008/0148785 A1
(43) Pub. Date: Jun. 26, 2008

(54) Washing Machine

(75) Inventors: Jong Chil Lee, Gyeonggi-do (KR); Bong Hwa Kwak, Incheon-si (KR); Su Hyang Kang, Incheon-si (KR)

Correspondence Address: OCCHIUTI ROHLICEK & TSAO, LLP, 10 FAWCETT STREET, CAMBRIDGE, MA, 02138, US

(73) Assignee: Daewoo Electronics Corporation, Seoul (KR)

(21) Appl. No.: 11/959,916

(22) Filed: Dec. 19, 2007

(30) Foreign Application Priority Data
Dec. 20, 2006 (KR) 10-2006-0131340

(51) Int. Cl. D06F 37/20; B29C 45/14

(52) U.S. Cl. 68/140; 264/328.1

(57) ABSTRACT

A washing machine having an improved coupling structure for coupling a drive unit to a tub is disclosed. The washing machine includes a bearing housing supporting a bearing, a water tub provided on the bearing housing by injection molding such that the bearing housing can be inserted into the tub, and a drive unit coupled to the tub. The drive unit includes a stator and a rotator. A fastening part is formed on the tub such that the stator can be coupled to the fastening part. In the washing machine, the drive unit is directly coupled to the tub without a separate member such as a base, thereby improving assembling efficiency while reducing work time. In addition, the bearing housing is formed with a blade to distribute applied stress to the tub and the bearing housing, thereby preventing damage of the bearing housing or the tub due to stress concentration.

### CROSS-REFERENCES TO RELATED APPLICATIONS

The present application claims priority to Korean patent application number 10-2006-0131340, filed on Dec. 20, 2006, which is incorporated by reference in its entirety.

### BACKGROUND OF THE INVENTION

1. Field of the Invention

The present invention relates to a washing machine, and more particularly to a washing machine that has an improved coupling structure for coupling a drive source to a tub.

2. Description of the Related Art

A drum type washing machine is a machine designed to wash laundry with detergent and water in a drum by rotating the drum about a horizontal axis with a drive force from a motor. The drum type washing machine performs a washing operation based on a frictional force between the laundry and the rotating drum, and has many advantages compared to agitating-type washing machines such as little damage of laundry, less entanglement, and use of laundry pounding and rubbing effects in a washing operation.

A conventional drum type washing machine and a drive source thereof will be described briefly with reference to the accompanying drawings.

FIG. 1 is a side sectional view of a conventional washing machine which employs an indirect drive system, and FIG. 2 is a cross-sectional view of a drive source of a direct drive type washing machine having a different configuration from that of the washing machine shown in FIG. 1.

Referring to FIG. 1, the conventional washing machine includes a tub 2 disposed inside a cabinet 1, and a drum 3 rotatably and concentrically mounted inside the tub 2. A motor 5a disposed below the tub 2 is connected to a motor pulley 18 via a shaft. A drum shaft is disposed behind the drum 3 and is provided with a drum pulley 19. The drum pulley 19 on the drum shaft is connected to the motor pulley 18 of the motor 5a via a belt 20 as a power transmission component.

A door 21 is mounted on a front side of the cabinet 1, with a gasket 22 interposed between the door 21 and the tub 2. A spring 23 is located between an upper inner side of the cabinet 1 and an upper outer side of the tub 2 to hold the tub 2, and a damper 24 is located between a lower inner side of the cabinet 1 and a lower outer side of the tub 2 to absorb vibration of the tub 2 that generally occurs during spin drying of the washing machine.

In the conventional washing machine, a drive force is delivered from the motor 5a to the drum 3 via the motor pulley 18, the drum pulley 19, and the belt 20 that connects the motor pulley 18 and the drum pulley 19. Since the drive force is delivered from the motor 5a to the drum 3 via the belt 20 between the motor pulley 18 and the drum pulley 19 instead of being directly delivered thereto, the conventional washing machine inevitably experiences energy loss during transmission of the drive force. Further, since the drive force is indirectly delivered from the motor 5a to the drum 3 through many components, such as the motor pulley 18, the drum pulley 19, the belt 20, etc., a great degree of noise is generated during transmission of the drive force. Further, in order to achieve transmission of the drive force from the motor 5a to the drum 3, it is necessary to have many components such as the motor pulley 18, the drum pulley 19, the belt 20, etc., which increases the work time required for assembly of the drive unit. Moreover, due to the increased number of components used for transmitting the drive force from the motor 5a to the drum 3 as described above, malfunction of the washing machine can occur frequently and at many places.

In the conventional washing machine constructed as described above, the drive force is indirectly delivered from the motor 5a to the drum 3 through the motor pulley, drum pulley, and belt, causing many problems, such as a high possibility of malfunction, severe noise, energy loss, reduction in washing efficiency, and the like. Additionally, in the conventional washing machine, the tub 2 is generally made of stainless steel, which is expensive, and has low formability as well as a heavy weight.

To solve the problems of the conventional washing machine as described above, a direct drive type washing machine has been proposed.

Referring to FIG. 2, the conventional direct drive type washing machine includes a tub 10 and a base 40. The tub 10 is located outside a bearing housing 30 that has a bearing B received therein to support a shaft. The base 40 surrounds the tub 10 and the bearing housing 30 so as to secure the tub 10 and the bearing housing 30.

In the conventional washing machine, it becomes difficult to couple together the components of the drive unit. This difficulty is due to the complicated shapes of a number of components of the drive unit, such as the tub 10, the bearing housing 30, and the base 40. Further, because the shapes are complicated, distortion and other product defects of productscan occur during the manufacture of the components of the drive unit, including the tub 10, the bearing housing 30, and the base 40, thereby causing size and shape mismatch between the components. A large degree of mismatch between the components causes a high frequency of manufacturing defects of the components for the drive unit. Further, use of the base 40, required for coupling the components, increases manufacturing costs. Therefore, there is a need for a drum type washing machine that overcomes these problems.

### SUMMARY OF THE INVENTION

The present invention is conceived to solve the problems of the conventional washing machine, and an aspect of the present invention is to provide a washing machine that has improved structure permitting ease of assembly of a drive source. Another aspect of the present invention is to provide a washing machine having reduced manufacturing costs.

In accordance with one aspect of the present invention, a washing machine includes: a bearing housing supporting a bearing; a tub provided on the bearing housing by injection molding such that the bearing housing is inserted into a wall of the tub; and a drive unit coupled to the tub, the drive unit including a stator and a rotator. In addition, the washing machine includes a fastening part formed on the tub such that the stator is coupled to the fastener.

The fastening part may be formed on the tub by injection molding.

The fastening part may be a boss hole.

The bearing housing may comprise a through-hole at a location corresponding to the location of the fastening part. The through-hole may be exposed to be coupled to the stator. Further, the bearing housing may further include a support rib formed around the through-hole.

The stator may include a fastening hole at a location corresponding to the location of the fastening part.

At least one of the bearing housing and the stator may be provided with a location determining member which identifies a correct location and facilitates alignment of the bearing housing with respect to the stator when the stator is coupled to the tub.

The washing machine may further include a fastening member securing the stator to the tub. The fastening member may include a screw.

The bearing housing may further include a blade extending outward therefrom. The blade may include a penetration hole, through which an injected material is introduced to firmly couple the tub and the bearing housing when injection molding the tub.

In accordance with another aspect of the present invention, a washing machine includes: a bearing housing having a through-hole formed therein; a tub provided on the bearing housing by injection molding such that the bearing housing is inserted within a wall of the tub, the tub being formed with a boss hole corresponding to the through-hole; a drive unit coupled to the tub, and including a stator and a rotator; and a fastening member passing through the through-hole and secured to the boss hole to secure the stator to the tub.

The bearing housing may further include a support rib formed around the through-hole.

At least one of the bearing housing and the stator may include a location determining member which identifies a correct location and facilitates alignment of the bearing housing with respect to the stator when the stator is coupled to the tub.

In accordance with another aspect of the present invention, a method of forming a washing machine tub includes a tub, the tub comprising a wall portion and a bearing housing, the bearing housing including a blade portion extending radially outward from an elongated hub portion, wherein the blade portion is formed having at least one through hole, the method of forming the tub comprising: injection molding the tub on the bearing housing such that at least a portion of the bearing housing is disposed within the wall portion of the tub, and forming the tub to include a boss hole at a location corresponding to the location of the at least one through-hole.

The blade portion is formed having a penetration hole, and during injection molding of the tub, injection material which constitutes the wall portion of the tub is introduced through the penetration hole so as to firmly couple the tub to the bearing housing.

### BRIEF DESCRIPTION OF THE DRAWINGS

The above and other objects, features and advantages of the present invention will become apparent from the following description of exemplary embodiments given in conjunction with the accompanying drawings, in which:

FIG. 1 is a side sectional view of a conventional indirect drive type washing machine;

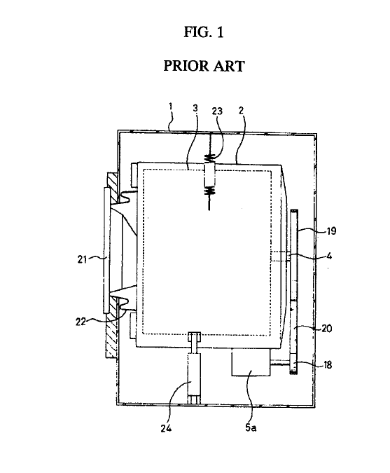

FIG. 2 is a cross-sectional view of a drive source of a conventional direct drive type washing machine having a different configuration from that of the washing machine shown in FIG. 1;

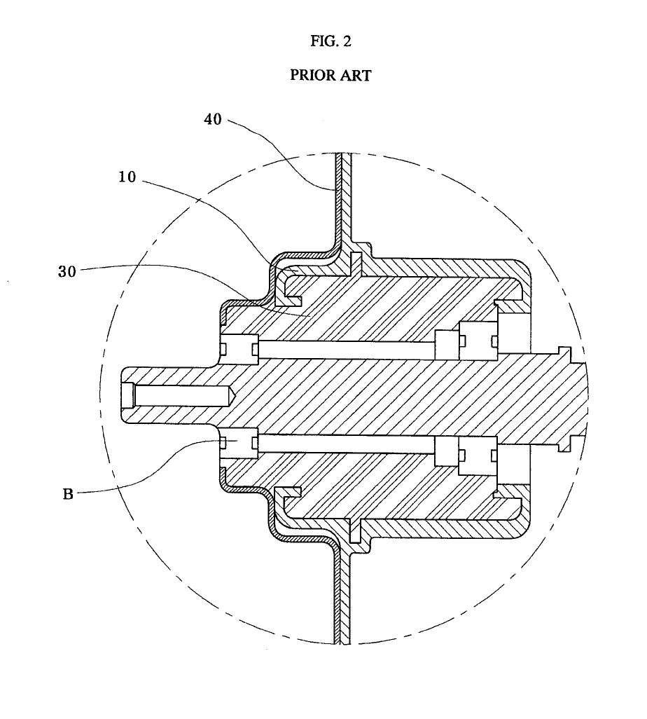

FIG. 3 is a side sectional view of a washing machine according to one embodiment of the present invention;

FIG. 4 is a schematic view of a coupling structure between a tub and a drive source according to one embodiment of the present invention;

FIG. 5 is a rear perspective view of a bearing housing shown in FIG. 4;

FIG. 6 is a front perspective view of a through-hole shown in FIG. 5; and

FIG. 7 is a view of a coupling structure between the bearing housing and the stator shown in FIG. 4.

### DETAILED DESCRIPTION OF THE INVENTION

Exemplary embodiments of the present invention will be described in detail with reference to the accompanying drawings. For convenience of description, the present invention will be described based on a drum type washing machine. The drawings are not to precise scale and may be exaggerated in thickness of lines or size of components for descriptive convenience and clarity only. Furthermore, terms used herein are defined in consideration of functions of components of the present invention and thus can be changed according to the custom or intention of users or operators. Therefore, definition of such terms should be determined according to overall disclosures set forth herein.

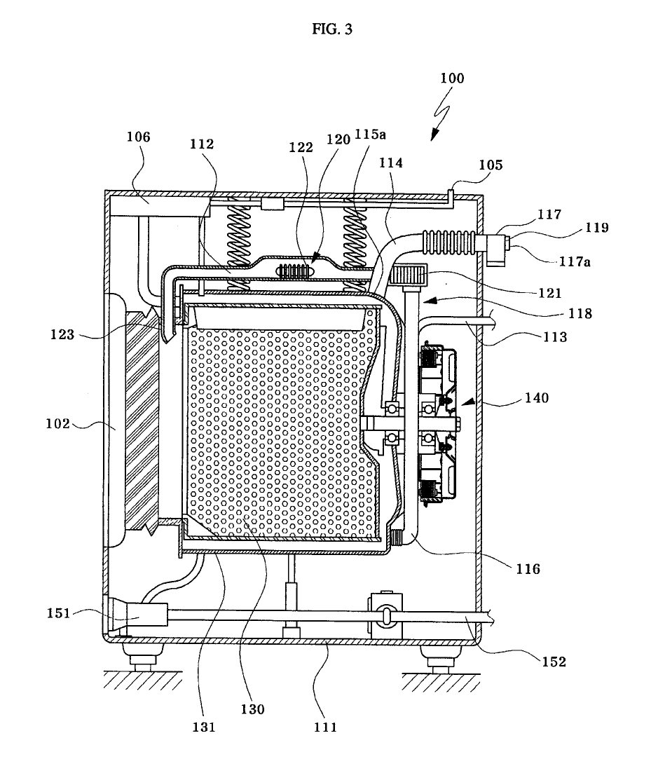

FIG. 3 is a side sectional view of a washing machine according to one embodiment of the present invention.

Referring to FIG. 3, the washing machine 100 of this embodiment includes a cabinet 111 which determines an external appearance of the washing machine 100. A tub 131 is disposed inside the cabinet 111, a drum 130 is rotatably disposed inside the tub 131, and a drive unit 140 is disposed behind the tub 131 to rotate the drum 54. The washing machine 100 also includes a spin drying unit 120 to dry laundry.

A water supply device 105 is disposed above the tub 131 to supply water from an outside of the cabinet 50 to the tub 131. When supplied to the tub 131 through the water supply device 105, water passes through a detergent container 106 where detergent may be contained. A drainage pump 151 and a drainage pipe 152 are located below the tub 131 to discharge water to the outside after a washing operation of the washing machine is completed. A door 102 is mounted to an opening that is formed on the front side of the cabinet 111, the opening permitting laundry to be placed into and taken out of the drum 130. Here, the front side indicates the left side of FIG. 3 and the rear side indicates the right side of the FIG. 3.

Although not shown in the drawings, multiple holes are formed on a circumferential surface and a rear side of the drum 130 such that air can flow therethrough. With this configuration, air can flow from the drum 130 to a space defined between the drum 130 and the tub 131 through the holes formed in the drum 130.

In the washing machine 100 according to this embodiment, after several repetitions of washing and rinsing operations, a spin drying operation is performed by the spin drying unit 120, which injects heated air into the drum 130 or the tub 131. In other words, the spin drying unit 120 heats and circulates air in order to dry washed laundry in the drum 130.

The spin drying unit 120 includes a heater 122 for heating air, a venting unit 121 for circulating heated air, a drying duct 112 serving as a passage through which heated air flows into the tub 131, and an air discharge pipe 114 disposed to communicate with the tub 131. The drying duct 112 is opened at one end 123 to allow the heated air to flow into the tub 131 therethrough. The one end 123 of the drying duct 112 is located to allow the heated air to flow into the drum 130 therethrough.

In this embodiment, the heater 122 is disposed inside the drying duct 112 between the venting unit 121 and an air inlet 123, that is, the one end 123 of the drying duct 112. The heater 122 is an electrical heater that generates heat by electric current, and the temperature of the heater 122 is controlled by a thermistor (not shown). The venting unit 121 includes a fan, which is rotated by a motor (not shown) to circulate the heated air.

Meanwhile, in order to achieve efficient spin drying, it is desirable to remove moisture in air. When air of high temperature is brought into contact with an article of low temperature, air is condensed to generate water on the article. A condenser 118 is disposed between the venting unit 121 and the tub 131 to remove moisture from heated air based on this principle. In other words, the condenser 118 allows cooling water, which has been supplied through a water supply pipe 113 disposed at an upper side of the washing machine 100, to flow on the wall of a condensation duct 116 such that air of high temperature and humidity within the condensation duct 116 can contact water of low temperature, thereby condensing water vapor to remove moisture within the drum 130.

In this embodiment, the water supply device 105, which supplies water to the tub 52, and the water supply pipe 113, which supplies cooling water to the condensation duct 116, are provided as separate components. Alternatively, cooling water can be directly supplied to the condensation duct 116 through the water supply device 105. This configuration is well known to those skilled in the art, and a detailed description thereof will be omitted herein. In the washing machine 100 of this embodiment, heated air is supplied to the tub 131 through the drying duct 112 for spin drying laundry, and air discharged from the tub 131 is brought into contact with cooling water through the condensation duct 116 and condensed into water. The condensed water is discharged to the outside through the drainage pipe 152 located below the tub 131.

The washing machine 100 includes the air discharge pipe 114, through which humid air from the spin drying operation can be discharged to the outside. The air discharge pipe 114 communicates with the tub 131 through one side 115a of the air discharge pipe 114 and communicates with the outside through the other side 117a thereof such that air can be discharged from the tub 131 to the outside therethrough. The other side 117a of the air discharge pipe 114 is provided with an extension part 117 where a filter 119 is located along with the fan (not shown), which is driven by the motor (not shown).

The air discharge pipe 114 is provided with a temperature sensor (not shown) which detects the temperature of air. The configuration and operation of the temperature sensor is well known to those skilled in the art, and a detailed description thereof will be omitted herein.

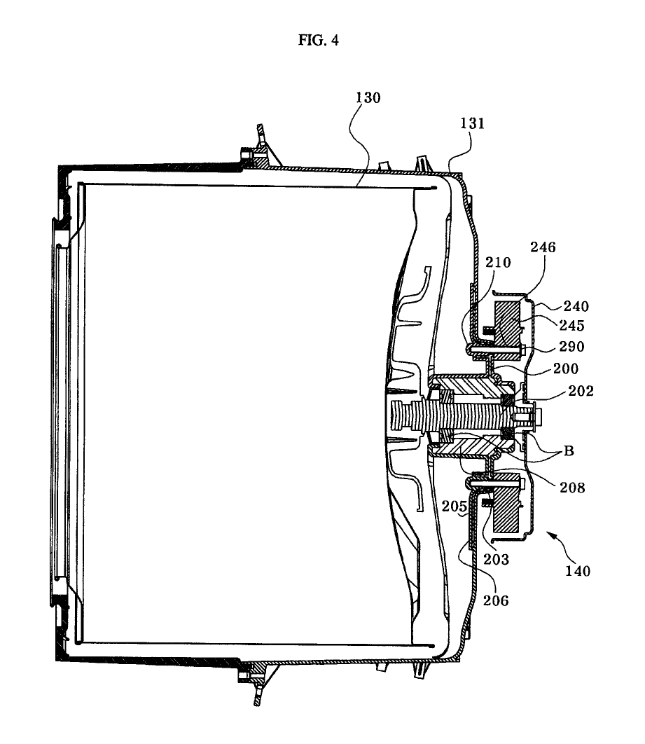

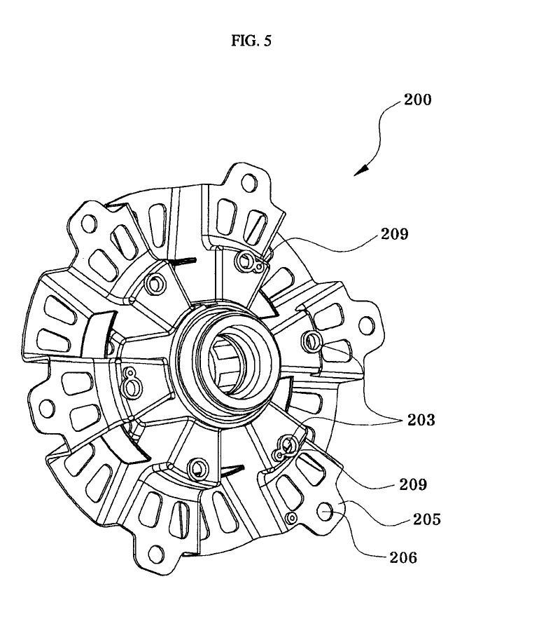

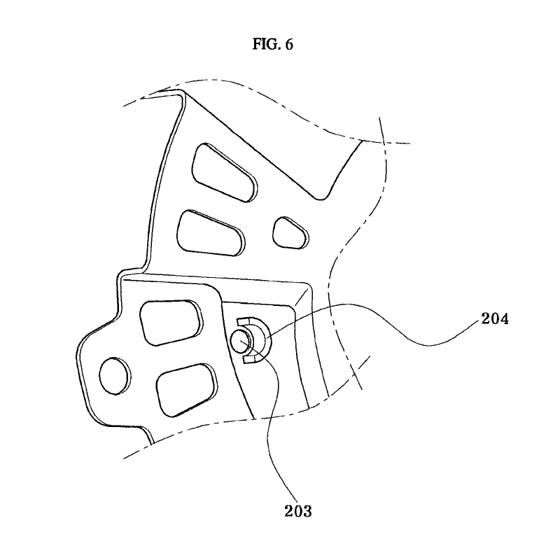

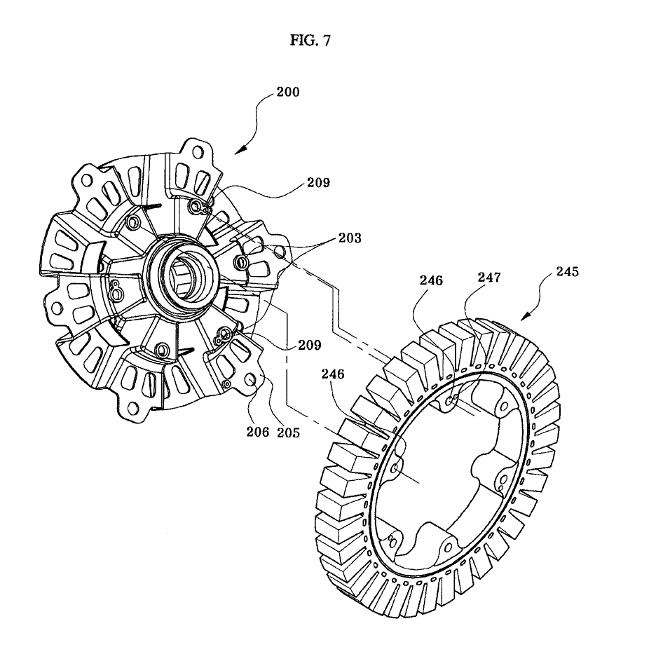

FIG. 4 is a schematic view of a coupling structure between a tub and a drive source according to one embodiment of the present invention, FIG. 5 is a rear perspective view of a bearing housing shown in FIG. 4, and FIG. 6 is a front perspective view of a through-hole shown in FIG. 5. Further, FIG. 7 is a view of a coupling structure between the bearing housing and the stator shown in FIG. 4.

Referring to FIG. 4, the drive unit 140 is provided on one side of the tub 131 to supply a rotational drive force for rotating the drum 130. The drive unit 140 is coupled to the tub 131, and includes a stator 245 and a rotator 240. The stator 245 is coupled to the tub 131, and the rotator 240, axially connected to the drum 130, is coupled to a drive shaft 202 that delivers the rotational force to the drum 130. The constructions and operations of the stator 245 and the rotator 240 are well known to those skilled in the art, and a detailed description thereof will be omitted herein.

A plurality of fastening parts 210 are formed on the tub 131 to permit the stator 245 to be coupled thereto. In the illustrated embodiment, six fastening parts 210 are formed on the tub 131, but a few or greater number of fastening parts 210 may be employed as required by the particular application. In order to improve manufacturing productivity and reduce work time, each fastening part 210 may be formed on the tub 131 by injection molding. For example, a fastening part 210 is preferably formed in a protrusion or coupling aperture shape on the tub 131. More preferably, the fastening part 210 is a boss hole which provides firm coupling between the stator 245 and the tub 131.

A bearing B is disposed on an outer surface of the drive shaft 202 and supports rotation of the drive shaft 202. In this embodiment, the bearing B is disposed on the outer surface at either end of the drive shaft 202 to support the rotation of the drive shaft 202. However, the supporting construction of the bearing B can be modified in various forms.

A bearing housing 200 receives the bearing B, and may be made of metal. In this embodiment, the bearing housing 200 is provided by injection molding, and then the tub 131 is formed on the bearing housing 200 by injection molding such that the bearing housing 200 is disposed within, and integrated to, a rear wall of the tub 131.

Referring to FIGS. 4 and 5, the bearing housing 200 is formed with a plurality of through-holes 203 at locations corresponding to the locations of the fastening parts 210. In order to secure the stator 245 to the tub 131, a fastening member 290 described below is inserted into each through-hole 203 and fastened to the fastening part 210. In order to facilitate insertion and coupling of the fastening member 290 with respect to the fastening part 210, the through-hole 203 may be exposed to the outside. Further, the bearing housing 200 may include a location determining member 209 that can adjust a location where the stator 245 is coupled to the tub 131. The location determining member may be provided on the stator 245. The location determining member may be provided to at least one of the bearing housing 200 and the stator 245. In this regard, it can be understood that the scope of the present invention is not limited to the embodiment as illustrated above, and that various modifications can be made according to the location of the location determining member 209 as described above.

The bearing housing 200 is formed with a blade 205 extending radially outward from an axially elongated hub portion 208. The hub portion 208 is generally coaxial with the drive shaft 202, and serves to support at least one bearing B. The blade 205 serves to distribute stress concentration on the bearing housing 200 and to prevent damage of the tub 131 or the bearing housing 200 due to torque generated during rotation. The blade 205 may be formed with a penetration hole 206. The penetration hole is provided adjacent an outer periphery of the blade 205. Hence, during injection molding of the tub 131 on the bearing housing 200, injection material which constitutes a body of the tub 131 is introduced through the penetration hole 206 and firmly couples the tub 131 and the bearing housing 200.

As shown in FIG. 5, the bearing housing 200 may be shaped so as to bend toward the tub 131 and away from the tub 131. A portion of the bearing housing 200 bent toward the tub 131 is inserted and integrated to the tub 131, and a portion of the bearing housing 200 bent away from the tub 131 is coupled to the stator 245. Accordingly, the blade 205 may be formed on the portion of the bearing housing 200 bent toward the tub 131, and the through-hole 203 may be formed on the portion of the bearing housing 200 bent away from the tub 131.

Referring to FIGS. 4 and 6, a support rib 204 protrudes around the through-hole 203 to restrict movement of the fastening member 290 when fastening the fastening member 290. The support rib 204 may be formed along the periphery of the through-hole 203.

Further, as shown in FIGS. 4 and 7, the stator 245 is formed with a plurality of fastening holes 246 at locations corresponding to the locations of the through-holes 203 and the fastening parts 210. Further, the stator 245 is formed with at least one location determining member 247 at a location corresponding to that of the location determining member 209 of the bearing housing 200. Thus, the stator 245 is coupled to the tub 131 by coupling the fastening member 290 to the fastening part 210 through the fastening hole 246 and the through-hole 203. In some embodiments, the fastening member 290 is press-fitted into the fastening part 210, which is not formed with a screw hole. In other embodiments, the fastening member 290 may include a screw in view of improvement of coupling force and reduction in work time.

Next, coupling between the drive unit and the tub of the washing machine according to the embodiment of the present invention will be described.

Referring to FIGS. 4, 5 and 7, the tub 131 is provided on the bearing housing 200 by injection molding such that the bearing housing 200 can be inserted to the tub 131. When injection molding the tub 131, a portion of the bearing housing 200 including the blade 205 is inserted into the tub 131, and the through-hole 203 and the location determining member 209 are exposed to the outside.

After insert injection molding, the location determining member 247 of the stator 245 is correspondingly assembled to the location determining member 209 of the bearing housing 200, and the stator 245 is then secured to the tub 131 by the fastening member 290. At this point, the fastening member 290 is press-fitted into the fastening part 210, which is formed on the tub 131, to ensure firm coupling between the stator 245 and the tub 131.

In the washing machine according to the embodiment with the construction as described above, the stator 245 can be directly coupled to the tub 131 without a separate member such as a base.

As is apparent from the above description, the washing machine according to the present invention includes a drive unit that is directly coupled to a tub without a separate member such as a base, thereby improving assembling efficiency while reducing work time. In addition, according to the invention, a bearing housing is provided with a blade to distribute applied stress to the tub and the bearing housing, thereby preventing damage of the bearing housing or the tub due to stress concentration. In addition, according to the invention, a stator is directly coupled to the tub by means of a fastening member, which reduces time for assembly while improving a fastening force. Further, according to the invention, a support rib is disposed on a portion of the bearing housing, into which the fastening member is inserted, to effectively restrict movement of the fastening member, thereby preventing the fastening member from being loosened due to vibration. Moreover, according to the invention, a location determining member is provided to prevent assembling errors that can occur during assembly of the drive unit, thereby preventing malfunction or damage of components due to the assembling errors.

Although the present invention has been described with reference to the embodiments and drawings, the embodiments and drawings are given by way of illustration only, and, it will be apparent to those skilled in the art that various modifications and equivalent embodiments can be made without departing from the scope of the present invention. Therefore, the scope of the present invention should be limited only by the accompanying claims.

What is claimed is:

1. A washing machine, comprising:
a bearing housing;
a tub provided on the bearing housing by injection molding such that at least a portion of the bearing housing is disposed in a wall of the tub;
a drive unit coupled to the tub, the drive unit including a stator and a rotator; and
a fastening part formed on the tub such that the stator can be coupled to the fastening part.

2. The washing machine according to claim 1, wherein the fastening part is formed on the tub by injection molding.

3. The washing machine according to claim 1, wherein the fastening part is a boss hole.

4. The washing machine according to claim 1, wherein the bearing housing comprises a through-hole at a location corresponding to the location of the fastening part.

5. The washing machine according to claim 4, wherein the through-hole is exposed to the exterior of the tub so as to permit coupling to the stator.

6. The washing machine according to claim 4, wherein the bearing housing further comprises a support rib formed around the through-hole.

7. The washing machine according to claim 1, wherein the stator comprises a fastening hole at a location corresponding to the location of the fastening part.

8. The washing machine according to claim 1, wherein at least one of the bearing housing and the stator is provided with a location determining member which facilitates alignment of the bearing housing with respect to the stator when the stator is coupled to the tub.

9. The washing machine according to claim 1, further comprising: a fastening member securing the stator to the tub at the fastening part.

10. The washing machine according to claim 9, wherein the fastening member comprises a screw.

11. The washing machine according to claim 1, wherein the bearing housing further comprises a blade extending outward therefrom.

12. The washing machine according to claim 11, wherein a penetration hole is formed in the blade, and a portion of the tub extends within the penetration hole to firmly couple the tub and the bearing housing.

13. A washing machine, comprising:
a bearing housing having a through-hole formed therein;
a tub provided on the bearing housing by injection molding such that the bearing housing is disposed within a wall of the tub, the tub being formed with a boss hole at a location corresponding to the location of the through-hole;
a drive unit coupled to the tub, the drive unit including a stator and a rotator; and
a fastening member extending from the stator, passing through the through-hole and being secured to the boss hole so as to secure the stator to the tub.

14. The washing machine according to claim 13, wherein the bearing housing further comprises a support rib formed around the through-hole.

15. The washing machine according to claim 13, wherein at least one of the bearing housing and the stator comprises a location determining member which facilitates alignment of the bearing housing with respect to the stator when the stator is coupled to the tub.

16. A method of forming a washing machine tub, the tub comprising a wall portion and a bearing housing, the bearing housing including a blade portion extending radially outward from an elongated hub portion, wherein the blade portion is formed having at least one through hole,
the method of forming the tub comprising:
injection molding the tub on the bearing housing such that at least a portion of the bearing housing is disposed within the wall portion of the tub, and
forming the tub to include a boss hole at a location corresponding to the location of the at least one through-hole.

17. The method of claim 16, wherein the blade portion is formed having a penetration hole, and
during injection molding of the tub, injection material which constitutes the wall portion of the tub is introduced through the penetration hole so as to firmly couple the tub to the bearing housing.
